(19) United States
(12) Patent Application Publication
(10) Pub. No.: US 2026/0178879 A1
(43) Pub. Date: Jun. 25, 2026

(54) LEARNING A DIVERSE COLLECTION OF ACTION SELECTION POLICIES BY COMPETITIVE EXCLUSION

(71) Applicant: DeepMind Technologies Limited, London (GB)

(72) Inventors: Peter Goran Sunehag, London (GB); Joel Zaidspiner Leibo, London (GB)

(21) Appl. No.: 19/124,359

(22) PCT Filed: Oct. 30, 2023
(86) PCT No.: PCT/EP2023/080200

§ 371 Date: Apr. 25, 2025

Related U.S. Application Data
(60) Provisional application No. 63/420,353, filed on Oct. 28, 2022.

(51) Int. Cl. G06N 3/045; G06N 3/084

(52) U.S. Cl. CPC G06N 3/045; G06N 3/084

(57) ABSTRACT

Methods, systems, and apparatus, including computer programs encoded on a computer storage medium, for training a collection of policy neural networks to select actions to be performed by an agent interacting with an environment to accomplish a task. In one aspect, a method comprises training the collection of policy neural networks by, for each episode of a plurality of episodes: designating, from the collection of policy networks (i) a target network and (ii) differentiated policy neural networks; controlling the agent using the target network; receiving task rewards that define a metric of performance on the task by the agent as controlled by the target network; training the target network using the task rewards; and training each differentiated network using modified rewards that encourage an increase in a measure of differentiation between the differentiated network and the target network.

### CROSS-REFERENCE TO RELATED APPLICATION

This application claims priority to U.S. Provisional Application No. 63/420,353, filed on Oct. 28, 2022. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations for training a collection of policy neural networks to select actions to be performed by an agent interacting with an environment to accomplish a task.

According to one aspect, there is provided a method performed by one or more computers, the method comprising: training a collection of policy neural networks to select actions to be performed by an agent interacting with an environment to accomplish a task, wherein the training comprises, for each episode of a plurality of episodes: designating: (i) one policy neural network as being a target policy neural network for the episode, and (ii) each other policy neural network as being a differentiated policy neural network for the episode; controlling the agent using the target policy neural network over a sequence of time steps in the episode, comprising: generating a trajectory of observation-action pairs, wherein each observation-action pair corresponds to a respective time step and comprises: (i) an observation characterizing a state of the environment at the time step, and (ii) an action performed by the agent at the time step; and receiving, for each time step, a respective task reward for the time step that defines a metric of performance on the task by the agent at the time step; and training the collection of policy neural networks on the trajectory of observation-action pairs, comprising: training the target policy neural network, by a reinforcement learning technique, using the task rewards; and training each differentiated policy neural network, by a reinforcement learning technique, using modified rewards that encourage an increase in a measure of differentiation between a target action selection policy defined by the target policy neural network and a differentiated action selection policy defined by the differentiated policy neural network.

In some implementations, increasing, for each differentiated policy neural network, the measure of differentiation between the target action selection policy and the differentiated action selection policy comprises, for one or more time steps in the episode: decreasing a value of the observation-action pair at the time step in the episode under the differentiated action selection policy.

In some implementations, the value of the observation-action pair at the time step in the episode under the differentiated action selection policy defines an expected cumulative measure of reward received over a sequence of time steps where: (i) the agent performs the action from the observation-action pair in response to the observation from the observation-action pair at a first time step in the sequence of time steps, and (ii) the agent performs actions selected in accordance with the differentiated action selection policy at each subsequent time step in the sequence of time steps.

In some implementations, training each differentiated policy neural network comprises, for each of one or more time steps in the episode: generating a predicted value of the observation-action pair at the time step using the differentiated policy neural network; generating a target value for the observation-action pair at the time step, wherein the target value is defined using the modified rewards; determining gradients of an reinforcement learning objective function that measures an error between: (i) the predicted value for the observation-action pair generated using the differentiated policy neural network, and (ii) the target value for the observation-action pair; and updating values of a set of neural network parameters of the differentiated policy neural network using the gradients.

In some implementations, the error comprises a squared-error.

In some implementations, for each time step in the episode, a modified reward for the time step is defined as having a default value.

In some implementations, for each time step in the episode, the default value of the modified reward for the time step is a predefined value.

In some implementations, for each time step in the episode, the default value of the modified reward for the time step is zero.

In some implementations, for each time step in the episode, the default value of the modified reward for the time step is a random value.

In some implementations, for each time step in the episode, the default value of the modified reward for the time step is a random value drawn from a probability distribution having a mean of zero.

In some implementations, for one or more time steps in the episode, the modified reward for the time step is different than the task reward for the time step.

In some implementations, training the target policy neural network, by the reinforcement learning technique, using the task rewards comprises: training the target policy neural network to encourage an increase in a cumulative measure of task rewards received when the agent is controlled using the target policy neural network.

In some implementations, training the target policy neural network comprises, for each of one or more time steps in the episode: generating a predicted value of the observation-action pair at the time step using the target policy neural network; generating a target value for the observation-action pair at the time step, wherein the target value is defined using the task rewards; determining gradients of an reinforcement learning objective function that measures an error between: (i) the predicted value for the observation-action pair generated using the target policy neural network, and (ii) the target value for the observation-action pair.

In some implementations, designating, for each episode of the plurality of episodes, one policy neural network as being the target policy neural network for the episode comprises: randomly sampling a policy neural network from the collection of policy neural networks; and designating the randomly sampled policy neural network as being the target policy neural network for the episode.

In some implementations, each policy neural network in the collection of policy neural networks comprises: an encoder subnetwork that is configured to process a network input that includes an observation characterizing a state of the environment at a time step to generate an embedding of the observation; and an action selection subnetwork that is configured to process the embedding of the observation to generate a network output that characterizes one or more actions in a set of possible actions.

In some implementations, the encoder subnetwork comprises one or more recurrent neural network layers.

In some implementations, the encoder subnetwork comprises one or more convolutional neural network layers.

In some implementations, the network output defines a score distribution over a set of possible actions.

In some implementations, each policy neural network in the collection of policy neural networks shares a same encoder subnetwork having a same set of encoder subnetwork parameters.

In some implementations, controlling the agent using the target policy neural network over the sequence of time steps in the episode comprises, for each time step in the episode: processing a network input that comprises an observation characterizing a state of the environment at the time step, using the target policy neural network, to generate a network output that characterizes one or more actions in a set of possible actions; and selecting the action to be performed by the agent at the time step using the network output.

In some implementations, for each time step in the episode, the network output generated by the target policy neural network at the episode defines a score distribution over the set of possible actions.

In some implementations, for each time step in the episode, selecting the action to be performed by the agent at the time step comprises: sampling an action, from the set of possible actions, in accordance with the score distribution over the set of possible actions.

In some implementations, for each time step in the episode, selecting the action to be performed by the agent at the time step comprises: selecting an action having a highest score, from among the set of possible actions, according to the score distribution over the set of possible actions.

In some implementations, the agent is a mechanical agent interacting with a real-world environment.

In another aspect, there is provided a method performed by one or more computers, the method comprising: controlling an agent by selecting actions to be performed by the agent in an environment to accomplish a task in the environment, wherein the agent is controlled using one or more policy neural networks that have each been trained according to the methods described herein.

In another aspect, there is provided one or more non-transitory computer storage media storing instructions that when executed by one or more computers cause the one or more computers to perform operations of the methods described herein.

In another aspect, there is provided a system comprising: one or more computers; and one or more storage devices communicatively coupled to the one or more computers, wherein the one or more storage devices store instructions that, when executed by the one or more computers, cause the one or more computers to perform operations of the methods described herein.

Particular embodiments of the subject matter described in this specification can be implemented so as to realize one or more of the following advantages.

This specification describes a training system for training a collection of policy neural networks to select actions to be performed by an agent interacting with an environment to accomplish a task (by performing the actions selected by one or more of the policy neural networks). In particular, the training system trains the collection of policy neural networks to achieve diversity among the collection of policy neural networks, where each policy neural network defines an action selection policy that occupies a respective “niche” in the space of possible action selection policies (“policy space”). (An action selection policy can be said to occupy a “niche”, e.g., if the action selection policy corresponds to a local optimum in policy space). After (or during) the training, an agent may interact with the environment (e.g. a real-world environment) to accomplish a task by performing actions selected by one or more of the policy neural networks processing observations characterizing states of the environment over a sequence of time steps.

The training system trains the collection of policy neural networks to encourage competitive exclusion among the individual policy neural networks. The training system encourages each policy neural network to define an action selection policy that occupies a unique niche in policy space. Intuitively, the training system generates gradients (e.g., of a reinforcement learning objective function, for use in adjusting the parameter values of the policy neural networks) that cause the action selection policies defined by the policy neural networks to become attracted to local optima in policy space. However, when a niche in policy space becomes occupied by an action selection policy corresponding to a policy neural network, the training system can be understood to generate gradients for other policy neural networks that flip direction to instead point away from the occupied niche in policy space.

The training system implements reinforcement learning training techniques to encourage competitive exclusion among the collection of policy neural networks. In particular, at each episode, the training system designates one of the policy neural networks as being a “target” policy neural network (defining a “target” action selection policy) for the episode, and designates the remaining policy neural networks as being “differentiated” policy neural networks (defining “differentiated” action selection policies) for the episode. The training system controls the agent during the episode using the target policy neural network and trains the target policy neural network on task rewards (e.g., characterizing a metric of performance of the agent on the task). The training system further trains the differentiated policy neural networks using modified rewards that encourage (incentivize) the differentiated action selection policies to differentiate from the target action selection policy. That is, during the episode, the modified rewards provide incentives that tend to cause the (differentiated) action selection policies defined by the respective differentiated policy neural networks to differ from the (target) action selection policy defined by the target policy neural network.

In particular, training the differentiated policy neural networks using the modified rewards may decrease value estimates, under the differentiated action selection policies, for the observation-action pairs transitioned into by the agent while under the control of the target policy neural network. Thus, over the course of multiple training episodes, when one policy neural network causes the agent to frequently transition into a particular observation-action pair, the value of the particular observation-action pair is decreased for the other policy neural networks. The particular observation-action pair can be understood as being claimed by one policy neural network as part of its associated niche, while the other policy neural networks are competitively excluded from the particular observation-action pair. In some implementations, the value estimate for an action under a differentiated action selection policy may be a reward or return that would be expected to result from the agent performing the action in response to an observation (and thereafter selecting future actions performed by the agent in accordance with the differentiated action selection policy). A value estimate may, for example, be a Q-value.

The training system can thus generate a diverse and effective collection of policy neural networks that define action selection policies occupying differentiated niches in policy space. In contrast, training a collection of policy neural networks using conventional techniques may result in the trained policy neural networks defining uniform action selection policies that occupy few niches in policy space (or even just a single niche in policy space). The training system can thus generate action selection policies that represent unique strategies for solving tasks that can be implemented to enable agents to perform tasks more effectively (e.g., more quickly), or even to perform tasks that would not be solvable using action selection policies generated by conventional methods.

The training system trains the collection of policy neural networks using efficient training techniques that enable reduced consumption of computational resources. For instance, at each episode, the training system trains the entire collection of policy neural networks on the trajectory of observation-action pairs generated at the episode (varying only the rewards associated with observation-action pairs according to whether each policy neural network is a target policy neural network or a differentiated policy neural network for the episode). The training system can thus train the collection of policy neural networks using fewer trajectories of observation-action pairs than would otherwise be required.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system.

FIG. 2 is a flow diagram of an example process for training policy neural networks.

FIG. 3 is a flow diagram of an example process for training a target neural networks.

FIG. 4 is a flow diagram of an example process for training differentiated neural networks.

FIG. 5 is a flow diagram of an example process for controlling an agent.

FIG. 6 illustrates example experimental results.

Like reference numbers and designations in the various drawings indicate like elements.

### DETAILED DESCRIPTION

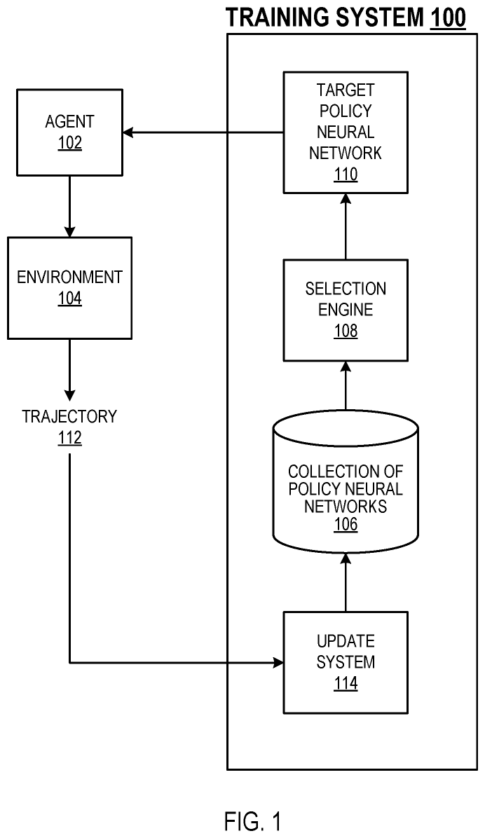

FIG. 1 shows an example training system 100. The training system 100 is an example of a system implemented as computer programs on one or more computers in one or more locations in which the systems, components, and techniques described below are implemented.

The training system 100 is configured to train one or more distinct policy networks within a collection of policy neural networks 106 that can select actions to be performed by an agent 102 interacting with an environment 104 in order to accomplish a task.

Each policy neural network within the collection of policy neural networks 106 can receive and process observations to select actions for the agent 102 to perform. Throughout this specification, an “observation” can refer to any appropriate data characterizing the state of an environment, e.g., data that is captured by a sensor, e.g. of the agent 102 interacting with the environment 104.

Each policy neural network within the collection of policy neural networks 106 can select actions for the agent 102 to perform at each time step of a sequence of time steps. Throughout this specification, the sequence of observations received by one of the policy networks and the actions selected by the policy neural network during a sequence of time steps are referred to as being part of an episode. The sequence of the pairs of observations and actions from a particular policy network for each time step in an episode are referred to as forming a trajectory 112 for the episode.

The agent 102 can interact with an environment 104 to perform the task in the environment 104, e.g., manipulating an object in the environment 104, navigating to a target location in the environment 104, collecting objects located throughout an environment 104, etc. The agent 102 can receive a task reward at a time step based on the state of the environment 104 at the time step and the action performed by the agent 102 at the time step. The task reward received at a time step can characterize the performance of the agent 102 on a task, e.g., a progress of the agent 102 toward completing the task as of the time step.

A few illustrative examples of agents, environments, actions, and tasks are described next.

In some implementations, the environment 104 is a real-world environment, the agent 102 is a mechanical agent (e.g. an electromechanical agent) interacting with the real-world environment, e.g., a robot or an autonomous or semi-autonomous land, air, or sea vehicle operating in or navigating through the environment, and the actions are actions taken by the mechanical agent in the real-world environment to perform a task. For example, the agent 102 may be a robot interacting with the environment 104 to accomplish a specific task, e.g., to locate an object of interest in the environment 104 or to move an object of interest to a specified location in the environment 104 or to navigate to a specified destination in the environment 104.

In these implementations, the observations may include, e.g., one or more of: images, object position data, and sensor data to capture observations as the agent 102 interacts with the environment 104, for example sensor data from an image, distance, or position sensor or from an actuator. For example, in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent 102. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent 102 or data from sensors that are located separately from the agent 102 in the environment 104.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment 104 the control of which has an effect on the observed state of the environment 104. For example, in the case of an autonomous or semi-autonomous land or air or sea vehicle the control signals may define actions to control navigation, e.g., steering, and movement e.g., braking and/or acceleration of the vehicle.

In some implementations, the environment 104 is a simulation of the above-described real-world environment, and the agent 102 is implemented as one or more computers interacting with the simulated environment. For example, the simulated environment may be a simulation of a robot or vehicle and the reinforcement learning system may be trained on the simulation and then, once trained, used in the real-world.

In some implementations, the environment 104 is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent 102 may comprise an electronic agent configured to control a manufacturing unit, or a machine such as a robot, that operates to manufacture the product. That is, the agent 102 may comprise a control system configured to control the manufacture of the chemical, biological, or mechanical product. For example, the control system may be configured to control one or more of the manufacturing units or machines or to control movement of an intermediate version or component of the product between the manufacturing units or machines.

As one example, a task performed by the agent 102 may comprise a task to manufacture the product or an intermediate version or component thereof. As another example, a task performed by the agent 102 may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general, the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or returns may relate to a metric of performance of the task. For example, in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use a resource the metric may comprise any metric of usage of the resource.

In general observations of a state of the environment 104 may comprise any electronic signals representing the functioning of electronic and/or mechanical items of equipment. For example a representation of the state of the environment 104 may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent 102 in the environment 104.

In some implementations the environment is 104 the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent 102 may be an electronic agent configured to control operation of the items of equipment, or to control operation of the ancillary, e.g., environmental, control equipment.

In general, the actions may be any actions that have an effect on the observed state of the environment 104, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment 104 may comprise any electronic signals representing the functioning of the facility or of equipment in the facility. For example, a representation of the state of the environment 104 may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example, in the case of a task to control, e.g., minimize, use of a resource, such as a task to control use of electrical power or water, the metric may comprise any metric of use of the resource.

In some implementations, the environment 104 is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent 102 may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example, in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid, the metric may relate to a measure of electrical power or energy transferred to the grid, or to a measure of electrical power or energy loss in the power generation facility.

In general, observations of a state of the environment may include any electronic signals representing the electrical or mechanical functioning of power generation equipment in the power generation facility. For example, a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power, or energy; temperature or cooling of the physical environment; fluid flow; or a physical configuration of the equipment; and observations of an electrical condition of the grid, e.g., from local or remote sensors. Observations of a state of the environment may also include one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way, the environment 104 may be a drug design environment such that each state is a respective state of a potential pharmaceutical drug and the agent 102 may be a computer system for determining elements of the pharmaceutical drug and/or a synthetic pathway for the pharmaceutical drug. The drug/synthesis may be designed based on a reward derived from a target for the drug, for example in simulation. As another example, the agent 102 may be a mechanical agent that performs or controls synthesis of the drug.

In some further applications, the environment 104 is a real-world environment and the agent 102 manages distribution of tasks across computing resources, e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent 102 may be an autonomous vehicle, and a user of the autonomous vehicle may provide textual or spoken instructions to the agent (e.g., to navigate to a particular location).

As another example, the environment 104 may be an electrical, mechanical or electromechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity e.g., that modify one or more of the observations. The rewards or return may comprise one or more metric of performance of the design of the entity. For example, the rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus, a design of an entity may be optimized, e.g., by reinforcement learning, and then the optimized design output for manufacturing the entity, e.g., as computer executable instructions; an entity with the optimized design may then be manufactured.

As previously described, the environment 104 may be a simulated environment. Generally, in the case of a simulated environment, the observations may include simulated versions of one or more of the previously described observations or types of observations and the actions may include simulated versions of one or more of the previously described actions or types of actions. For example, the simulated environment may be a motion simulation environment, e.g., a driving simulation or a flight simulation, and the agent 102 may be a simulated vehicle navigating through the motion simulation. In these implementations, the actions may be control inputs to control the simulated user or simulated vehicle. Generally, the agent 102 may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to recreate in the real-world environment. For example, the system may be partly trained using a simulation of a mechanical agent in a simulation of a particular real-world environment, and afterwards deployed to control the real mechanical agent in the particular real-world environment. Thus, in such cases, the observations of the simulated environment relate to the real-world environment, and the selected actions in the simulated environment relate to actions to be performed by the mechanical agent in the real-world environment.

The simulated environment may be a video game and the agent may be a character within the video game. For example, the system may be used to select actions for a player character in the video game during training or evaluation of the system and, after training, or evaluation, or both, are complete, may be deployed for controlling a player character in the video game. The system can be trained to control a character within the video game to perform certain tasks within the video game. Observations of the video game environment can characterize information regarding the state of the video game, e.g., scores in the video game, amounts of particular resources in the video game, and so on. Observations of the video game environment can also characterize properties of entities in the video game, e.g., the position of entities in the video game, the trajectories of entities in the video game, the current state of entities within the video game, and so on.

Optionally, in any of the above implementations, the observation at any given time step may include data from a previous time step that may be beneficial in characterizing the environment 104, e.g., the action performed at the previous time step, the reward received at the previous time step, or both.

In some implementations, the environment 104 is a chemistry environment, and the agent 102 can interact with the chemistry environment by selecting chemical components (e.g., molecules) to chemically react according to certain criteria (e.g., temperature, pressure, etc.). The agent 102 can perform tasks in the chemistry environment such as synthesizing new compounds, maximizing energy created by selected reactions, etc. Observations of the chemistry environment can characterize, e.g., the temperature of the environment 104, the pressure of the environment 104, the chemical components currently present in the environment 104, etc.

Each policy neural network within the collection of policy neural networks 106 can have any appropriate neural network architecture. For instance, each policy neural network can include neural network layers of any appropriate type (e.g., convolutional layers, fully connected layers, recurrent layers, attention layers, etc.) in any appropriate number (e.g., 5 layers, 10 layers, or 50 layers), and connected in any appropriate configuration (e.g., as a linear sequence of layers or as a directed graph of layers). In some cases, the policy neural networks of the collection 106 do not all share the same neural network architecture.

In general, each policy neural network in the collection of networks 106 can have any appropriate architecture to process observations of the state of the environment 104 and produce outputs characterizing one or more actions in a set of possible actions. In some implementations, the policy neural networks can produce network outputs that define score distributions over a set of possible actions.

Each policy neural network in the collection of networks 106 can have any appropriate architecture for processing observations of the state of the environment 104. For example, if the observations include text data, the policy neural networks can include subnetworks configured to process the text data, such as Transformer networks (e.g. networks comprising one or more self- and/or cross-attention layers). As another example, if the observations include image data, the policy neural networks can include subnetworks configured to process image data, such as convolutional neural networks or visual Transformer networks. As another example, if the observations include time series data, the policy neural networks can include subnetworks configured to process time series data, such as recurrent neural networks, LSTM networks, or causal attention networks.

In some implementations, each policy neural network in the collection of networks 106 can include an encoder subnetwork configured to process observations characterizing states of the environment 104 and generate corresponding embeddings characterizing the observations. When the policy neural networks include encoder subnetworks, each policy neural network can include an action selection subnetwork configured to generate a network output characterizing one or more actions in a set of possible actions by processing embeddings output by the encoder subnetwork for the policy network. In some implementations, the encoder subnetworks can include one or more recurrent neural network layers. In some implementations, the encoder subnetworks can include one or more convolutional neural network layers. In some implementations, each policy neural network in the collection of networks 106 can include the same encoder subnetwork having a same set of encoder neural network parameters.

The system 100 can train the collection of policy neural networks 106 over a sequence of episodes.

The system 100 includes a selection system 108. For each episode, the selection system can designate one policy neural network from the collection 106 as being a target policy neural network 110 for the episode. For each episode, the selection system 108 can designate each policy neural network other than the target network 110 as being a differentiated policy neural network for the episode.

For each episode, the system 100 can control the agent 102 agent using the target neural network 110 to generate a trajectory 112 of observation-action pairs for the episode. The system 100 can receive respective task rewards for each time step of the episode that define a metric of performance on the task by the agent at the time step.

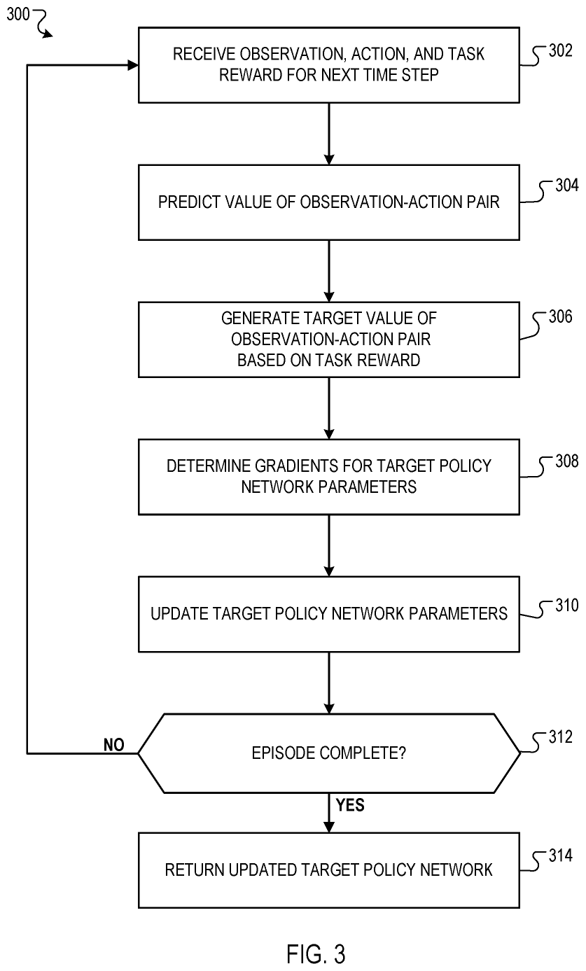

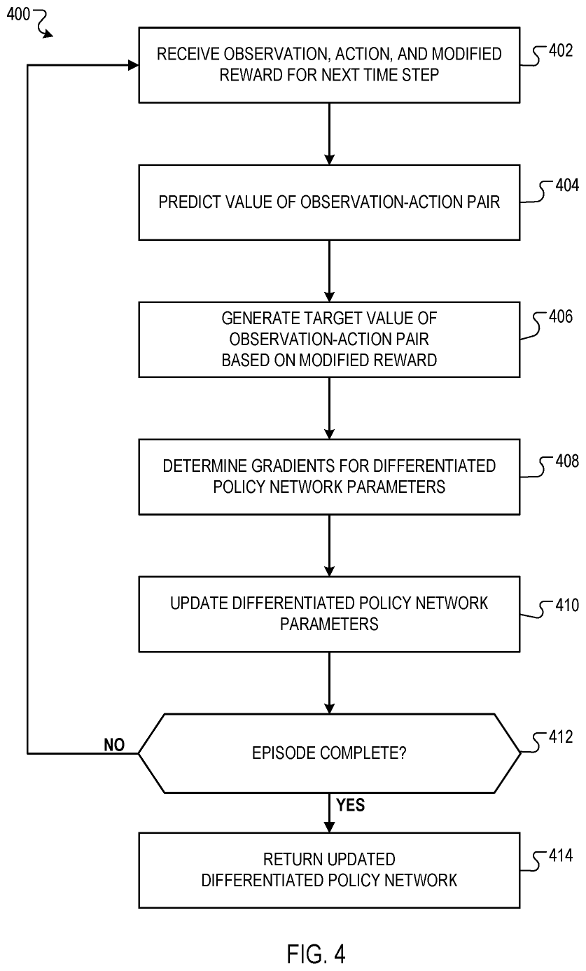

The system 100 includes an update system 114. For each episode, the update system 114 can process the received rewards and the trajectory 112 to train the collection of policy neural networks 106 while encouraging competitive exclusion among the collection of policy neural networks. The update system 114 can encourage competitive exclusion by training the target neural network based on the received rewards and training the differentiated neural networks using modified rewards that discourage the differentiated networks from adopting the policy of the target network. The process of training the target neural network is described in further detail below with reference to FIG. 3. The process of training the differentiated neural networks is described in further detail below with reference to FIG. 4.

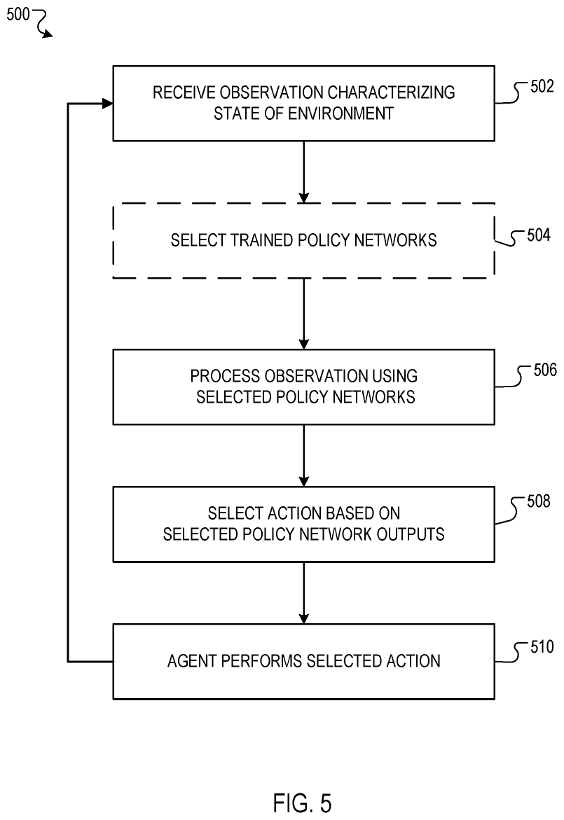

In some implementations, after training the collection of policy neural networks 106, the system 100 can use one or more of the trained networks to control the agent 102 to accomplish the task. The process of controlling the agent using one of the trained policy neural networks is described in further detail below with reference to FIG. 5.

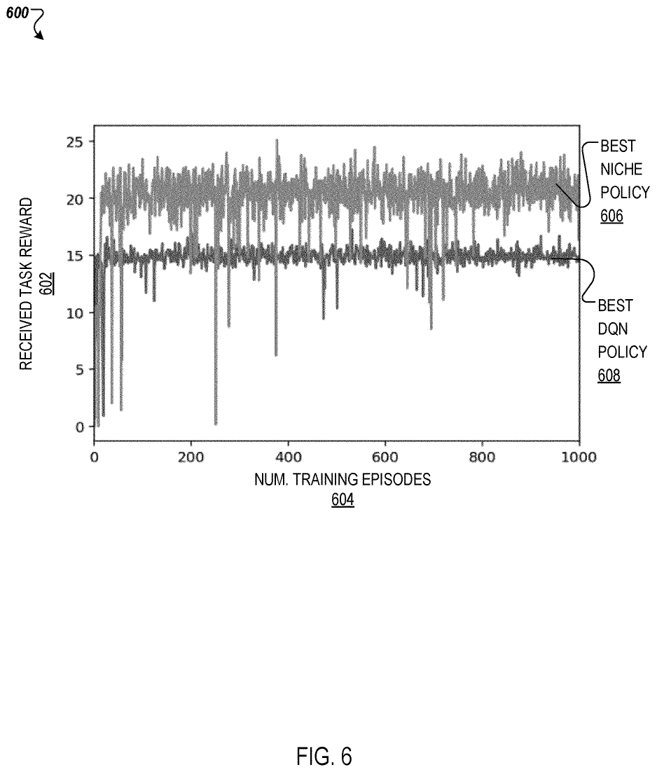

As described above, the system 100 can train the collection of policy neural networks 106 based on a principle of competitive exclusion. The system 100 can thus generate a diverse and effective collection of policy neural networks 106 that define action selection policies occupying differentiated niches in policy space. Once trained by the system 100, the collection of policy neural networks 106 can include multiple unique strategies for solving the task. As illustrated in further detail with reference to FIG. 6, by including multiple unique strategies for solving the task, the collection of trained policy neural networks 106 can attain better performance for performing the task.

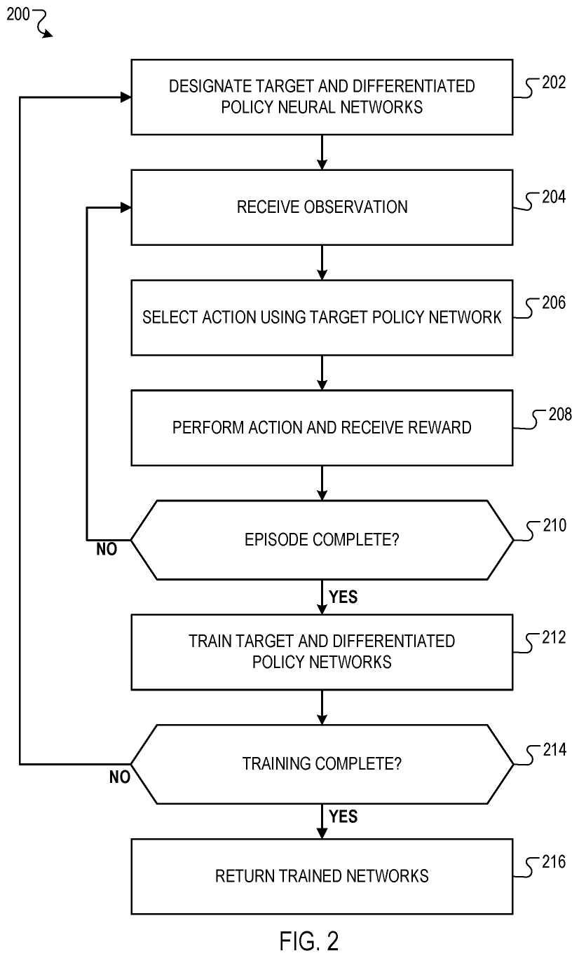

FIG. 2 is a flow diagram of an example process for training policy neural networks. For convenience, the process 200 will be described as being performed by a system of one or more computers located in one or more locations. For example, a training system, e.g., the training system 100 of FIG. 1, appropriately programmed in accordance with this specification, can perform the process 200.

The system performs the process 200 to train a collection of policy neural networks. The process 200 trains the collection of policy neural networks to appropriately select actions to be performed by an agent interacting with an environment in order to accomplish a task.

The environment can be a real-world environment, the agent can be a mechanical agent (e.g. an electro-mechanical agent) interacting with the real-world environment, and the actions can be actions taken by the mechanical agent in the real-world environment to perform a task. For example, the agent can be a robot or an autonomous or semi-autonomous land, air, or sea vehicle operating in or navigating through the environment. The environment can be a simulation of a real-world environment and the agent can be implemented as one or more computers interacting with the simulated environment. For example, the simulated environment may be a simulation of a robot or vehicle and the reinforcement learning system may be trained on the simulation and then, once trained, used in the real-world.

The process 200 trains the collection of policy networks over a sequence of training episodes. For each episode in the sequence of training episodes, the system receives observations, selects actions for the agent to perform in the environment, and receives rewards characterizing the performance of the agent over a sequence of time steps for the episode.

For each episode, the system designates one of the collection of networks as a target neural network and designates the other networks of the collection as differentiated neural networks for the episode (step 202). As an example, the system can follow a predetermined order for the collection of networks to select the target network for the episode. As another example, the system can select the target network by sampling from a distribution (e.g., a uniform distribution) over the collection of networks.

For each time step of the episode, the system receives an observation for the time step (step 204). The observations can include any real-world or simulated data collected by the agent to perform the task. For example, the observations can include images, object position data, and sensor data captured as the agent interacts with the environment. As a further example, the observations can include sensor data from an image, distance, or position sensor or from an actuator.

The system processes the observation using the target neural network and selects an action for the agent to perform at the time step (step 206). As an example, the target neural network can process the observation to determine a particular action, and the system can select the particular action for the agent to perform at the time step. As another example, the target neural network can process the observation to determine a score distribution over a set of possible actions, and the system can sample or select a particular action based on the score distribution. For instance, the system can select the action to be performed by the agent as the action associated with the highest score in the score distribution. As another example, the system can process the score distribution using a softmax function to generate a probability distribution over the set of possible actions, and then sample the action to be performed by the agent from the probability distribution.

The system controls the agent to perform the selected action and receives a reward for the time step (step 208). The reward received at the time step can be any appropriate task reward that characterizes the performance of the agent on the task. For example, the reward for the time step can characterize the progress of the agent toward completing the task as of the time step. The reward can, as appropriate, utilize negative or zero values to characterize undesirable performance on the task.

The system can determine whether the episode is complete (step 210). The system can use any of a variety of methods to determine that the episode is complete. For example, the system can determine that the episode is complete after a predetermined number of time steps for the episode. As another example, the system can determine that the episode is complete based on the performance of the agent during the episode, e.g., when the agent receives a predetermined threshold reward, when the agent completes the task, and so on.

The system processes the trajectory of observation-action pairs and the received rewards to train the neural networks (step 212). The system trains the target neural network based on the received task rewards using a reinforcement learning technique. For instance, the system can train the target neural network such that the agent, when performing actions selected in accordance with the action selection policy of the target network, receives an increased cumulative measure of rewards. The system can use any of a variety of reinforcement learning techniques, e.g., reinforcement learning techniques such as policy gradients, Q-learning, actor critic methods, etc., to train the target neural network. A specific example process of training the target neural network is described in further detail below with reference to FIG. 3.

The system trains the differentiated neural networks based on modified rewards using a reinforcement learning technique. The system trains each differentiated neural network such that the action selection policy of the differentiated neural network attains an increasing measure of differentiation from the action selection policy of the target neural network. The system can use any of a variety of reinforcement learning techniques, e.g., reinforcement learning techniques such as policy gradients, Q-learning, actor critic methods, etc., to train the differentiated neural networks. A specific example process of training the differentiated neural networks is described in further detail below with reference to FIG. 4.

The system can determine when the training is complete (step 214). If the training is not complete, the system can continue to the next episode. The system can use any of a variety of methods to determine that the training is complete. For example, the system can determine that the training is complete after processing a predetermined number of episodes. As another example, the system can determine that training is complete when the performance of the trained policy networks, e.g., as measured by the rewards received by the trained networks in performing the task, satisfies a predetermined performance criterion. As an example, the predetermined performance criterion can be satisfied when the best performing policy network satisfies a predetermined performance threshold. As another example, the predetermined performance criterion can be satisfied when a certain number or certain fraction of the policy networks satisfy a predetermined performance threshold.

When the system determines that the training is complete, the system can return the trained collection of neural networks (step 216). In some implementations, the system can use one or more of the trained policy neural networks to control the agent to accomplish the task. An example process of controlling the agent is described in further detail below with reference to FIG. 5.

FIG. 3 is a flow diagram of an example process for training a target policy neural network. For convenience, the process 300 will be described as being performed by a system of one or more computers located in one or more locations. For example, a training system, e.g., the training system 100 of FIG. 1, appropriately programmed in accordance with this specification, can perform the process 300.

The system receives, for each time step in an episode, data defining the observation for the time step, the action performed by the agent at the time step, and the task reward received at the time step (step 302). The task reward received at a time step can characterize the performance of the agent on the task, e.g., a progress of the agent towards completing the task as of the time step.

The system generates, for one or more time steps in the episode, a predicted value of the observation-action pair at the time step using the target neural network (step 304). The predicted value of the observation-action pair can be an expected cumulative measure of reward received over a sequence of time steps where: (i) the agent performs the action from the observation-action pair in response to the observation from the observation-action pair at a first time step in the sequence of time steps, and (ii) the agent performs actions selected in accordance with the target action selection policy at each subsequent time step in the sequence of time steps.

As an example, the cumulative measure of reward can be a sum of expected individual rewards, rₜ, received at future time steps, following:

$${R}_{t} = {\sum }_{j \geq 0} {r}_{t + j}$$

Where rᵢ denotes a reward expected for the i-th time step.

As a further example, the cumulative measure of reward can be a sum of time discounted expected individual rewards, rₜ, received at future time steps, following:

$${R}_{t} = {\sum }_{j \geq 0} {ϵ}^{j} {r}_{t + j}$$

Where rᵢ denotes a reward expected for the i-th time step and ∈∈(0,1) is a discount factor.

The system can predict the value of the observation-action pair following:

$${\hat{R}}_{t} = {Q}_{θ} ( {o}_{t} , {a}_{t} )$$

Where \hat{R}ₜ is the predicted value for the time step, Q_{θ} is the Q-function modeled by the target network having parameters θ, and (oₜ,aₜ) is the observation-action pair for the time step.

The system can generate a target value of the observation-action pair for the time step using the received task rewards (step 306). In particular, the system can generate the target value for the observation-action pair as a cumulative measure of the task rewards received over a sequence of time steps starting at the time step of the observation-action pair.

The system determines gradients with respect to the target policy neural network parameters based on the predicted value and the target value of the observation-action pair for the time step (step 308). In particular, the system can determine gradients of a loss function with respect to the target network parameters.

The loss function for the target policy network can be any loss that can appropriately train the target network to perform the task. As an example, the system can define the loss function for the target neural network following:

$${{ℒ}_{t} = {( {\hat{R}}_{t} - {R}_{t} )}^{2} = {Q}_{θ} ( {o}_{t} , {a}_{t} ) - {R}_{t} )}^{2}$$

where \hat{R}ₜ is the predicted value of the observation-action pair and Rₜ is the target value of the observation-action pair.

The system can update the target policy neural network parameters based on the determined gradients (step 310). The system can use any appropriate method to update the target network parameters based on the determined gradients. As an example, the system can update the target network parameters using a process of stochastic gradient descent following:

$$θ ← θ - α {∇}_{θ} {ℒ}_{t}$$

Where α>0 is a learning rate.

As another example, the system can use modifications of stochastic gradient descent that include, for example, momentum and weight decay. As a further example, the system can use methods such as Adam, AdaGrad, RMSprop, etc. to update the target network parameters.

At each time step, the system can determine whether the episode is complete (step 312). If the episode is not complete, the system can continue to process the next time step for the episode.

When system determines that the episode is complete, the system can return the updated target policy neural network (step 314).

FIG. 4 is a flow diagram of an example process for training a differentiated policy neural network. For convenience, the process 400 will be described as being performed by a system of one or more computers located in one or more locations. For example, a training system, e.g., the training system 100 of FIG. 1, appropriately programmed in accordance with this specification, can perform the process 400.

For each time step in a trajectory, the system receives an observation-action pair and a modified reward for the time step (step 402). The modified reward can be a modification of the task reward received by the target network at the time step. The task reward can be modified by any appropriate method to discourage the differentiated network from learning the same strategy for the task as the target neural network. For example, the modified reward,

$${r}_{t}^{′} ,$$

can modify the task reward, rₜ, for the time step with a discount factor, ∈∈[0,1), following:

$${r}_{t}^{′} = ϵ {r}_{t}$$

In some implementations, the modified reward can have a default value (e.g. a default value that is independent of the task reward received by the target network). As an example, default value of the modified reward can be a predefined value, such as zero. As another example, the modified reward can have a random default value as sampled from a distribution of default values. As a further example, the distribution of default values can have a mean of zero.

The system can predict a value of the observation-action pair for the time step (step 404). In particular, the differentiated neural network can model a Q-function that can process the observation-action pair in order to predict the value of the observation-action pair. The predicted value of the observation-pair can be an expected cumulative measure of reward received over a sequence of time steps where: (i) the agent performs the action from the observation-action pair in response to the observation from the observation-action pair at a first time step in the sequence of time steps, and (ii) the agent performs actions selected in accordance with the differentiated action selection policy at each subsequent time step in the sequence of time steps.

As an example, the cumulative measure of reward can be a sum of expected individual modified rewards, r′ₜ, received at future time steps, following:

$${R}_{t}^{′} = {\sum }_{j \geq 0} {r}_{t + j}^{′}$$

Where r′ₜ denotes a modified reward expected for the i-th time step.

As a further example, the cumulative measure of reward can be a sum of time discounted expected individual modified rewards, r′ₜ, received at future time steps, following:

$${R}_{t}^{′} = {\sum }_{j \geq 0} {ϵ}^{j} {r}_{t + j}^{′}$$

Where r′ₜ denotes a modified reward expected for the i-th time step and ∈∈(0,1) is a discount factor.

The system can predict the value of the observation-action pair following:

$${\hat{R}}_{t}^{′} = {Q}_{θ}^{′} ( {o}_{t} , {a}_{t} )$$

Where \hat{R}′ₜ is the predicted value for the time step, Q′_{θ} is the Q-function modeled by the differentiated network having parameters θ, and (oₜ,aₜ) is the observation-action pair for the time step.

The system can generate a target value of the observation-action pair for the time step using the modified task reward (step 406). In particular, the system can generate the target value for the observation-action pair as a cumulative measure of the modified task rewards received over a sequence of time steps starting at the time step of the observation-action pair.

The system determines gradients with respect to the differentiated policy neural network parameters based on the predicted value and the target value of the observation-action pair for the time step (step 408). In particular, the system can determine gradients of a loss function with respect to the differentiated network parameters.

The loss function for the differentiated policy network can be any loss that can appropriately discourage the differentiated network from learning the same strategy as the target network. As an example, the system can define the loss function for the differentiated neural network following:

$${ℒ}_{t} = {( {\hat{R}}_{t}^{′} - {R}_{t}^{′} )}^{2} = {( {Q}_{θ}^{′} ( {o}_{t} , {a}_{t} ) - {R}_{t}^{′} )}^{2}$$

where r′ₜ is the predicted value for the time step and r′ₜ is the target value for the time step.

The system can update the differentiated policy neural network parameters based on the determined gradients (step 410). The system can use any appropriate method to update the differentiated network parameters based on the determined gradients. As an example, the system can update the differentiated network parameters using a process of stochastic gradient descent following:

$$θ ← θ - α {∇}_{θ} {ℒ}_{t}$$

Where α>0 is a learning rate.

As another example, the system can use modifications of stochastic gradient descent that include, for example, momentum and weight decay. As a further example, the system can use methods such as Adam, AdaGrad, RMSprop, etc. to update the target network parameters.

At each time step, the system can determine whether the episode is complete (step 412). If the episode is not complete, the system can continue to process the next time step for the episode.

When system determines that the episode is complete, the system can return the updated differentiated policy neural network (step 414).

FIG. 5 is a flow diagram of an example process for process for controlling an agent using the policy neural networks. For convenience, the process 500 will be described as being performed by a system of one or more computers located in one or more locations. For example, a training system, e.g., the training system 100 of FIG. 1, appropriately programmed in accordance with this specification, can perform the process 500.

The system can use the process 500 to control an agent to perform the task based on the trained collection of policy networks. The system can control the agent to perform the task over a sequence of time steps.

At each time step, the system can receive an observation characterizing the state of the environment (step 502).

At each time step, the system can optionally select one or more trained policy networks from the collection of trained networks to process the observation for the time step (step 504). Particular networks within the collection of trained policy of neural networks may, on average, achieve better performance for the task. Additionally, as described above, when trained following a principle of competitive exclusion, the collection of policy neural networks can include multiple unique strategies (action selection policies) for solving the task. Different strategies may achieve better performance for the task under different circumstances. The system can select, based on observations from the environment, which networks from the collection of trained networks are most likely to achieve the best performance for the task.

The system can use any appropriate method to select the one or more trained networks. For example, the system can select the one or more best performing networks from the collection of trained networks. As another example, the system can determine a probability distribution over the collection of trained neural networks, e.g., a distribution determined by the performance of the networks, and select trained networks by sampling from the distribution. As another example, the system can generate predictions of the performance of the trained networks based on the received observation, and can select the one or more predicted best performing trained networks for the current state of the environment.

The system can determine when to select the one or more networks from the collection of trained policy neural networks by any appropriate method. For example, the system can select the one or more trained networks at the first time step controlling the agent, based on the first received observation. As another example, the system can select the one or more trained networks on a fixed schedule, selecting the networks based on the current observation at the start of every interval of a predetermined number of time steps. As another example, the system can track the actual performance of the agent while controlling the agent and can select the one or more trained networks when the actual performance of the agent falls below a predetermined threshold, e.g., when the actual performance falls below an expected performance of the collection of trained networks.

The system can process the current observation for the time step using the one or more selected trained policy networks to generate network outputs characterizing one or more proposed actions (step 506).

The system can select an action for the agent to perform for the time step based on the generated network outputs (step 508). The system can then select the action to be performed from the set of proposed actions. As an example, the system can select the action from the selected action having the largest predicted value. As another example, the system can determine a distribution over the set of proposed actions, e.g., a distribution with likelihoods proportional to the predicted values for the proposed actions, and select the action to be performed by sampling from the distribution.

The agent can finally perform the selected action for the time step (step 510).

The system can continue to control the agent for subsequent time steps using the same process. The system can end controlling the agent by any of a variety of means. For example, the system can end controlling the agent after a pre-determined number of time steps. As another example, the system can end controlling the agent when it determines that the agent has completed the task, e.g., by processing an observation that indicates that the agent has completed the task or by receiving a signal that the agent has completed the task.

FIG. 6 illustrates example experimental results obtained using a collection of policy neural networks as trained using the techniques described above.

The illustrated experimental results demonstrates the best performing niche policy network 606 from a collection of policy networks trained following a principle of competitive exclusion as compared with the best performing conventional deep Q policy network 608 from a collection of policy networks trained using conventional deep Q-learning technique. The vertical axis indicates the actual task rewards 602 received by the compared policy networks. The horizontal axis indicates the number of training episodes 604 used to train the compared collections of policy networks. In this example experiment, the two networks are trained to perform an artificial chemistry task selecting metabolic reactions within a simulated metabolic pathway and the task rewards are simulated energy gains from following the metabolic reactions selected by the policy networks. As illustrated by the example experimental results, the described techniques for training a collection of policy neural networks using a principle of competitive exclusion can enable the policy networks to attain better performance in reinforcement learning tasks compared to conventional training methodologies.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
training a collection of policy neural networks to select actions to be performed by an agent interacting with an environment to accomplish a task, wherein the training comprises, for each episode of a plurality of episodes:
designating: (i) one policy neural network as being a target policy neural network for the episode, and (ii) each other policy neural network as being a differentiated policy neural network for the episode;
controlling the agent using the target policy neural network over a sequence of time steps in the episode, comprising:
generating a trajectory of observation-action pairs, wherein each observation-action pair corresponds to a respective time step and comprises: (i) an observation characterizing a state of the environment at the time step, and (ii) an action performed by the agent at the time step; and
receiving, for each time step, a respective task reward for the time step that defines a metric of performance on the task by the agent at the time step; and
training the collection of policy neural networks on the trajectory of observation-action pairs, comprising:
training the target policy neural network, by a reinforcement learning technique, using the task rewards; and
training each differentiated policy neural network, by a reinforcement learning technique, using modified rewards that encourage an increase in a measure of differentiation between a target action selection policy defined by the target policy neural network and a differentiated action selection policy defined by the differentiated policy neural network.

2. The method of claim 1, wherein for each differentiated policy neural network, increasing the measure of differentiation between the target action selection policy and the differentiated action selection policy comprises, for one or more time steps in the episode:
decreasing a value of the observation-action pair at the time step in the episode under the differentiated action selection policy.

3. The method of claim 2, wherein the value of the observation-action pair at the time step in the episode under the differentiated action selection policy defines an expected cumulative measure of reward received over a sequence of time steps where:
(i) the agent performs the action from the observation-action pair in response to the observation from the observation-action pair at a first time step in the sequence of time steps, and
(ii) the agent performs actions selected in accordance with the differentiated action selection policy at each subsequent time step in the sequence of time steps.

4. The method of claim 2, wherein for each differentiated policy neural network, training the differentiated policy neural network comprises, for each of one or more time steps in the episode:
generating a predicted value of the observation-action pair at the time step using the differentiated policy neural network;
generating a target value for the observation-action pair at the time step, wherein the target value is defined using the modified rewards;
determining gradients of an reinforcement learning objective function that measures an error between: (i) the predicted value for the observation-action pair generated using the differentiated policy neural network, and (ii) the target value for the observation-action pair; and
updating values of a set of neural network parameters of the differentiated policy neural network using the gradients.

5. The method of claim 4, wherein the error comprises a squared-error.

6. The method of claim 1, wherein for each time step in the episode, a modified reward for the time step is defined as having a default value.

7. The method of claim 6, wherein for each time step in the episode, the default value of the modified reward for the time step is a predefined value.

8. The method of claim 7, wherein for each time step in the episode, the default value of the modified reward for the time step is zero.

9. The method of claim 6, wherein for each time step in the episode, the default value of the modified reward for the time step is a random value.

10. The method of claim 9, wherein for each time step in the episode, the default value of the modified reward for the time step is a random value drawn from a probability distribution having a mean of zero.

11. The method of claim 1, wherein for one or more time steps in the episode, the modified reward for the time step is different than the task reward for the time step.

12. The method of claim 1, wherein training the target policy neural network, by the reinforcement learning technique, using the task rewards comprises:
training the target policy neural network to encourage an increase in a cumulative measure of task rewards received when the agent is controlled using the target policy neural network.

13. The method of claim 12, wherein training the target policy neural network comprises, for each of one or more time steps in the episode:
generating a predicted value of the observation-action pair at the time step using the target policy neural network;
generating a target value for the observation-action pair at the time step, wherein the target value is defined using the task rewards;
determining gradients of an reinforcement learning objective function that measures an error between: (i) the predicted value for the observation-action pair generated using the target policy neural network, and (ii) the target value for the observation-action pair.

14. The method of claim 1, wherein for each episode of the plurality of episodes, designating one policy neural network as being the target policy neural network for the episode comprises:
randomly sampling a policy neural network from the collection of policy neural networks; and
designating the randomly sampled policy neural network as being the target policy neural network for the episode.

15. The method of claim 1, wherein each policy neural network in the collection of policy neural networks comprises:
an encoder subnetwork that is configured to process a network input that includes an observation characterizing a state of the environment at a time step to generate an embedding of the observation; and
an action selection subnetwork that is configured to process the embedding of the observation to generate a network output that characterizes one or more actions in a set of possible actions.

16. The method of claim 15, wherein the encoder subnetwork comprises one or more recurrent neural network layers.

17. The method of claim 15, wherein the encoder subnetwork comprises one or more convolutional neural network layers.

18. The method of claim 15, wherein the network output defines a score distribution over a set of possible actions.

19. (canceled)

20. (canceled)

21. (canceled)

22. (canceled)

23. (canceled)

24. (canceled)

25. (canceled)

26. One or more non-transitory computer storage media storing instructions that when executed by one or more computers cause the one or more computers to perform operations comprising:
training a collection of policy neural networks to select actions to be performed by an agent interacting with an environment to accomplish a task, wherein the training comprises, for each episode of a plurality of episodes:
designating: (i) one policy neural network as being a target policy neural network for the episode, and (ii) each other policy neural network as being a differentiated policy neural network for the episode;
controlling the agent using the target policy neural network over a sequence of time steps in the episode, comprising:
generating a trajectory of observation-action pairs, wherein each observation-action pair corresponds to a respective time step and comprises: (i) an observation characterizing a state of the environment at the time step, and (ii) an action performed by the agent at the time step; and
receiving, for each time step, a respective task reward for the time step that defines a metric of performance on the task by the agent at the time step; and
training the collection of policy neural networks on the trajectory of observation-action pairs, comprising:
training the target policy neural network, by a reinforcement learning technique, using the task rewards; and
training each differentiated policy neural network, by a reinforcement learning technique, using modified rewards that encourage an increase in a measure of differentiation between a target action selection policy defined by the target policy neural network and a differentiated action selection policy defined by the differentiated policy neural network.

27. A system comprising:
one or more computers; and
one or more storage devices communicatively coupled to the one or more computers, wherein the one or more storage devices store instructions that, when executed by the one or more computers, cause the one or more computers to perform operations comprising:
training a collection of policy neural networks to select actions to be performed by an agent interacting with an environment to accomplish a task, wherein the training comprises, for each episode of a plurality of episodes:
designating: (i) one policy neural network as being a target policy neural network for the episode, and (ii) each other policy neural network as being a differentiated policy neural network for the episode;
controlling the agent using the target policy neural network over a sequence of time steps in the episode, comprising:
generating a trajectory of observation-action pairs, wherein each observation-action pair corresponds to a respective time step and comprises: (i) an observation characterizing a state of the environment at the time step, and (ii) an action performed by the agent at the time step; and
receiving, for each time step, a respective task reward for the time step that defines a metric of performance on the task by the agent at the time step; and
training the collection of policy neural networks on the trajectory of observation-action pairs, comprising:
training the target policy neural network, by a reinforcement learning technique, using the task rewards; and
training each differentiated policy neural network, by a reinforcement learning technique, using modified rewards that encourage an increase in a measure of differentiation between a target action selection policy defined by the target policy neural network and a differentiated action selection policy defined by the differentiated policy neural network.
